(19) United States
(12) Patent Application Publication
(10) Pub. No.: US 2008/0216691 A1
(43) Pub. Date: Sep. 11, 2008

(54) PRINTING PLATE LOCK MECHANISMS

(76) Inventor: Ronald F. Stephens, Granger, IN (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/864,025

(22) Filed: Sep. 28, 2007

Related U.S. Application Data
(60) Provisional application No. 60/893,076, filed on Mar. 5, 2007.

(51) Int. Cl. B41F 13/10

(52) U.S. Cl. 101/378

(57) ABSTRACT

A plate lock system for use with cylinder slots having inwardly-angled slot walls. The system includes at least one lead clamp assembly having at least one lead clamp positioned adjacent at least one inwardly-angled slot wall, at least one trail clamp assembly having at least one trail clamp, and at least one register assembly having at least one register. At least one of the lead clamp assembly, the trail clamp assembly and the register assembly is a modular assembly having moving parts that are assembled together in a manner that allows limited relative movement between the moving parts. The modular assembly can be installed into the print cylinder slot through the slot opening without disassembling the moving parts. Also provided are printing plate clamp assemblies, a printing plate lock systems, and printing plate register assemblies.

### CLAIM OF PRIORITY

The present application claims the benefit of U.S. Provisional Application No. 60/893,076, filed on Mar. 5, 2007, which is incorporated herein by reference.

### FIELD OF THE INVENTION

The present invention relates to lock mechanisms used to secure printing plates to web press cylinders.

### BACKGROUND OF THE INVENTION

Web presses for newspapers and other large or small volume publications use cylinders to transfer images from printing plates to paper. Typically, a printing press plate cylinder is manufactured with two or four longitudinal cylinder slots. These slots typically extend along the outer surface of the cylinder in parallel with the cylinder centerline and rotation axis. Printing plate lock mechanisms fit into the cylinder slots to hold the ends of flexible printing plates and securely hold the flexible plates on the cylinder. On a typical cylinder, each lock includes mechanisms to hold the leading edge of one printing plate and the trailing edge of another printing plate. Depending on the printing requirements, a cylinder slot may mount a single flexible printing plate, referred to as a double truck, or two single-wide plates. Thus, a combination of four double truck flexible plates or up to eight single-wide flexible plates can be mounted on one plate cylinder. Printers place a high value on aligning the plates properly, because failing to do so can cause the printed product to appear distorted, particularly in four-color printing operations. Thus, it is very important for the locks to hold the printing plates securely, and in proper registration.

With rising newsprint prices, newspapers and other publications have started to reduce the printed paper web width to control cost. Newspapers are currently reducing web widths from a historical 55-inch web width to a 46-inch web width, and further reductions to 44-inch and possibly even 40-inch web widths or smaller are likely. To accommodate such reductions in web width, the width of flexible printing plates must be reduced accordingly. A number of lock mechanisms have been developed and attempt to accommodate web width reductions. For example, U.S. Pat. No. 6,401,617, which is incorporated herein by reference, discloses a printing plate lock mechanism that allows for reducing web widths, but does not appear able to handle a 55-inch to a 46-inch web-width reduction without replacing numerous parts of the lock mechanism. Furthermore, when the width of a flexible printing plate is reduced, current designs require more parts to correctly and precisely position the flexible plates to maintain color register on the printed web.

Another significant and common problem with existing lock mechanisms is the long time required for and complexity of installing, repairing, replacing, and removing the lock mechanisms. Typical current lock mechanisms have many small components that must be installed or maintained at the printing press before and during operation. Because the cylinder slots are relatively narrow and not accessible from their ends, the many parts of these typical locks must be hand-assembled, piece-by-piece, into the slots. This is particularly difficult when the installer can only access the cylinder slots from below, and must install the parts overhead. The large number of small components in current designs also increases the likelihood that components will be dropped during installation or become dislodged during operation, thus getting lost or wedged in the printing press, which can lead to significant press damage. This problem can be further exacerbated by the cylinder slot design, which in many cases has a generally inverted V-shape that is narrow at the cylinder surface and expands as it progresses towards the cylinder axis. Such narrow-slot slots are commonly used, and provide the cylinder with a greater total printing surface by reducing the unused area over the lock mechanism.

The printing process is harsh on lock mechanism components, and the end product produced by the printing process is time-sensitive. The complexity of current assemblies and the inability to quickly replace failed components in the lock mechanism leads to inefficiency and additional costs. Adding to the problem of current lock designs is the fact that print plate cylinder locks are replaced with some frequency, in addition to being replaced when they become worn out.

In view of these and other problems, there remains a need to provide an improved print cylinder lock mechanism.

### SUMMARY OF THE INVENTION

In a first exemplary aspect, the invention may provide a printing plate lock system for use with a print cylinder slot having inwardly-angled slot walls that terminate at a slot opening. The system has at least one lead clamp assembly with a plurality of lead clamp parts that are assembled together to form the lead clamp assembly. The lead clamp assembly has at least one lead clamp positioned adjacent at least one inwardly-angled wall of the print cylinder slot. The system also has at least one trail clamp assembly with a plurality of trail clamp parts that are assembled together to form the trail clamp assembly. The trail clamp assembly has at least one trail clamp. The system further includes at least one register assembly having a plurality of register parts that are assembled together to form the register assembly. The register assembly has at least one register. At least one of the lead clamp assembly, the trail clamp assembly and the register assembly is a modular assembly having moving parts that are assembled together in a manner that allows limited relative movement between the moving parts. The modular assembly can be installed into the print cylinder slot through the slot opening without disassembling the moving parts.

In another exemplary aspect, the invention may provide a printing plate clamp assembly for use with a print cylinder slot having inwardly-angled slot walls that terminate at a slot opening. The assembly includes a base adapted to be rigidly mounted in the print cylinder slot, a plate lock movably mounted to the base, a biasing device adapted to apply a force to move the plate lock relative to the base along a first direction, and a retainer adapted to limit the distance the plate lock can travel in the first direction. At least a portion of the printing plate clamp assembly is wider than the slot opening, and the printing plate clamp assembly is adapted to be passed through the slot opening and mounted in the print cylinder slot without disassembling the printing plate clamp assembly.

In another exemplary aspect, the invention may provide a printing plate clamp assembly having a base adapted to be rigidly mounted in a print cylinder slot. The base has a central cavity with one or more inwardly-angled base walls and a clamp slot located at the end of the one or more inwardly-angled base walls. A plate lock is provided generally within the cavity and movable relative to the base, and a biasing device is provided to apply a force to move the plate lock relative to the base along a first direction towards the clamp slot. The plate lock is retained within the cavity with respect to movement in the first direction, and the printing plate clamp assembly is adapted to be mounted in a print cylinder slot without disassembling the printing plate clamp assembly.

In yet another exemplary aspect, the invention may provide a printing plate lock system having at least one first plate clamp assembly adapted to be mounted in a print cylinder slot, and at least one second plate clamp assembly adapted to be mounted in the print cylinder slot. At least a portion of the second plate clamp assembly overlies at least a portion of the second plate clamp assembly, and the first plate clamp assembly and the second plate clamp assembly are simultaneously mounted in the print cylinder slot by at least one common fastener. One of the first plate clamp assembly and the second plate clamp assembly is a lead clamp adapted to lock a printing plate leading edge, and the other clamp assembly is a trail clamp adapted to lock a printing plate trailing edge.

In still another exemplary aspect, the invention may provide a printing plate register assembly for use with a print cylinder slot having inwardly-angled slot walls that terminate at a slot opening. The register assembly has a base adapted to be rigidly mounted in the print cylinder slot, and a register movably mounted to the base. The register has first and second register surfaces that underlie and face respective ones of the inwardly-angled slot walls. The register assembly also includes a biasing device adapted to apply a force to move the register relative to the base along a first direction, and a retainer adapted to limit the distance the register can travel in the first direction. The register assembly is adapted to be passed through the slot opening and mounted in the print cylinder slot without disassembling the register assembly.

### BRIEF DESCRIPTION OF THE DRAWINGS

FIG. 1 is an exploded perspective view of a first embodiment of a modular printing plate lock mechanism of the present invention.

FIG. 2 is a cross-sectional view of the register assembly of FIG. 1 shown installed in a cylinder slot.

FIG. 3 is a cross-sectional view of the plate lead clamp assembly of FIG. 1 shown installed in a cylinder slot.

FIG. 4 is a cross-sectional view of the tail plate clamp assembly of FIG. 1 shown installed in a cylinder slot.

FIG. 5 is a top assembled view of the embodiment of FIG. 1.

FIG. 5A is a cross-sectional view shown along line I-I of FIG. 5.

FIG. 5B is a cross-sectional view shown along line II-II of FIG. 5.

FIG. 5C is a cross-sectional view shown along line III-III of FIG. 5.

FIG. 5D is a cross-sectional side view shown along line IV-IV of FIG. 5.

FIG. 6 is an exploded perspective view of a second embodiment of a modular printing plate lock mechanism of the present invention.

FIG. 7 is a cross-sectional view of the register assembly of FIG. 6 shown installed in a cylinder slot.

FIG. 8 is a cross-sectional view of the plate clamp assemblies of FIG. 6 shown installed in a cylinder slot.

FIG. 9 is a top assembled view of the embodiment of FIG. 6.

FIG. 9A is a cross-sectional view shown along line I-I of FIG. 9.

FIG. 9B is a cross-sectional view shown along line II-II of FIG. 9.

FIG. 9C is a cross-sectional view shown along line III-III of FIG. 9.

FIG. 9D is a cross-sectional side view shown along line IV-IV of FIG. 9.

FIG. 10 is an isometric view of a tool for installing a trail lock into a trail lock assembly of the present invention.

FIGS. 11A-D are partially cutaway side views of an exemplary lead clamp assembly shown as it is rotated into a cylinder slot.

FIGS. 12A-D are partially cutaway side views of an exemplary trail clamp assembly shown as it is rotated into a cylinder slot.

FIGS. 13A-D are partially cutaway views of an exemplary mounting arrangement for lead and trail clamp assemblies.

FIGS. 14A-E are partially cutaway views of an exemplary register assembly shown as it is installed into a cylinder slot.

### DETAILED DESCRIPTION OF PREFERRED EMBODIMENTS

The present invention provides a number of improvements to printing press plate cylinder lock mechanisms that may be used separately or in conjunction. In one aspect, the present disclosure encompasses an invention providing a modular printing plate lock mechanism designed to reduce the number of parts needed to be installed in the press cylinder and accommodate a variety of web widths. The modular mechanism may be easily scaled to accommodate various web widths without requiring any significant retooling or replacement parts. In other aspects, the present disclosure encompasses inventions providing new and useful printing plate lead clamps, trail clamps and registers and features relating thereto, and such devices and features may be used as modular devices or otherwise. Further variations and combinations of the features described herein may be made by those of ordinary skill in the art, and such further combinations may comprise further inventions encompassed by the present disclosure.

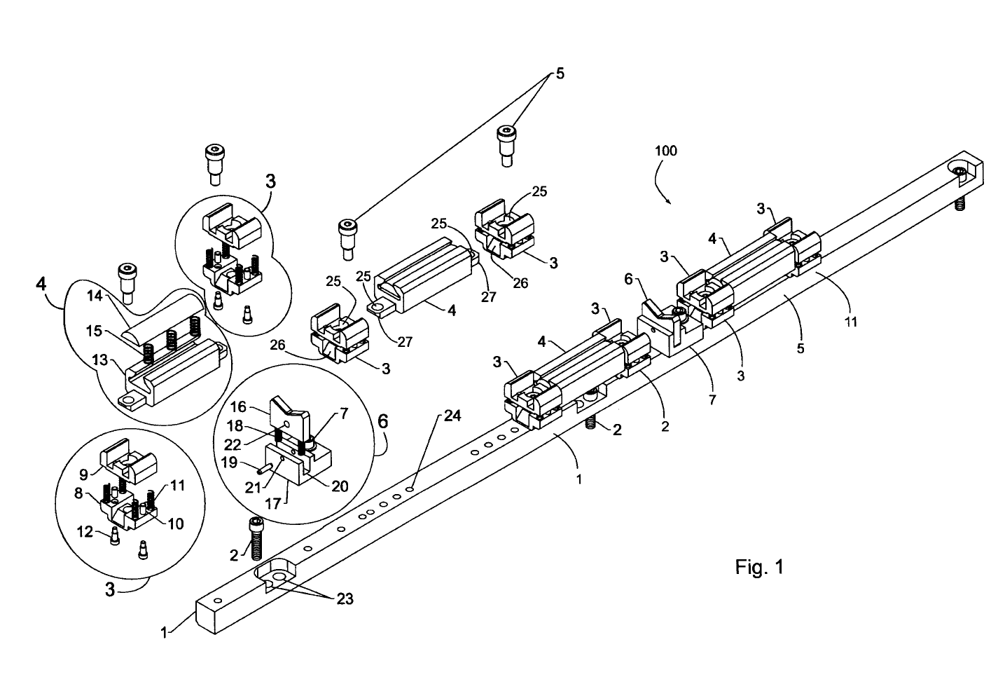

Referring now to FIG. 1, an embodiment of a modular printing plate lock mechanism is shown. One or more of these mechanisms, or portions of the mechanism, may be installed in a printing press cylinder slot to lock printing plates in place and/or position the plates in proper registration. As will be appreciated by persons of ordinary skill in the art, a single printing press cylinder typically has two to four cylinder slots. These slots typically extend longitudinally on the outer surface of the cylinder in parallel with the cylinder axis, and are spaced evenly around the circumference of the cylinder. A series of printing plates are mounted to the cylinder around its circumference, with each plate extending from one slot, where it is mounted by a lead clamp, to the next slot, where it is mounted by a tail clamp. Registration devices may be provided as part of or in conjunction with the locks to ensure that the plates are properly aligned on the cylinder. In some cases, a single plate may extend between each adjacent pair of slots, but more typically, two single-wide plates are mounted between each pair of slots. Of course, other numbers of slots and printing plates are possible. Thus, it will be understood that a typical printing press cylinder can have multiple lock mechanisms, with one or more lock mechanisms being located in each slot. The present invention is not limited to any particular number of configuration of slots or plate mounting regime.

As shown in FIG. 1, an exemplary lock mechanism may comprise a number of assemblies or parts that are installed into a print cylinder slot. The lock mechanism may include lead clamp assemblies 3, trail clamp assemblies 4, and plate register assemblies 6, and some or all of these parts may be mounted in a print cylinder slot by a filler bar 1. In the shown example, there is a single filler bar 1, eight lead clamp assemblies 3, four trail clamp assemblies 4, and two plate register assemblies 6. The shown example has two lock sets (each set having four lead clamp assemblies 3, two trail clamp assemblies 4 and a single register assembly 6) mounted on a single filler bar 1 for mounting two plates in a side-by-side arrangement. If a single plate is to be mounted, only one lock set may be used, and more than two lock sets can also be provided in a single print cylinder slot or on a single filler bar 1. These parts can, of course, be used in any variety of configurations, and it is not required for all of the parts to be used in any given embodiment. For example, the register assemblies 6 may be omitted or replaced by register assemblies having a different or modified construction. Furthermore, in one embodiment, each of the foregoing assemblies may be pre-assembled before being inserted into the cylinder slot. Each of these parts or assemblies is discussed in detail below, followed by a detailed description of how each part or assembly may be installed into the press cylinder slot.

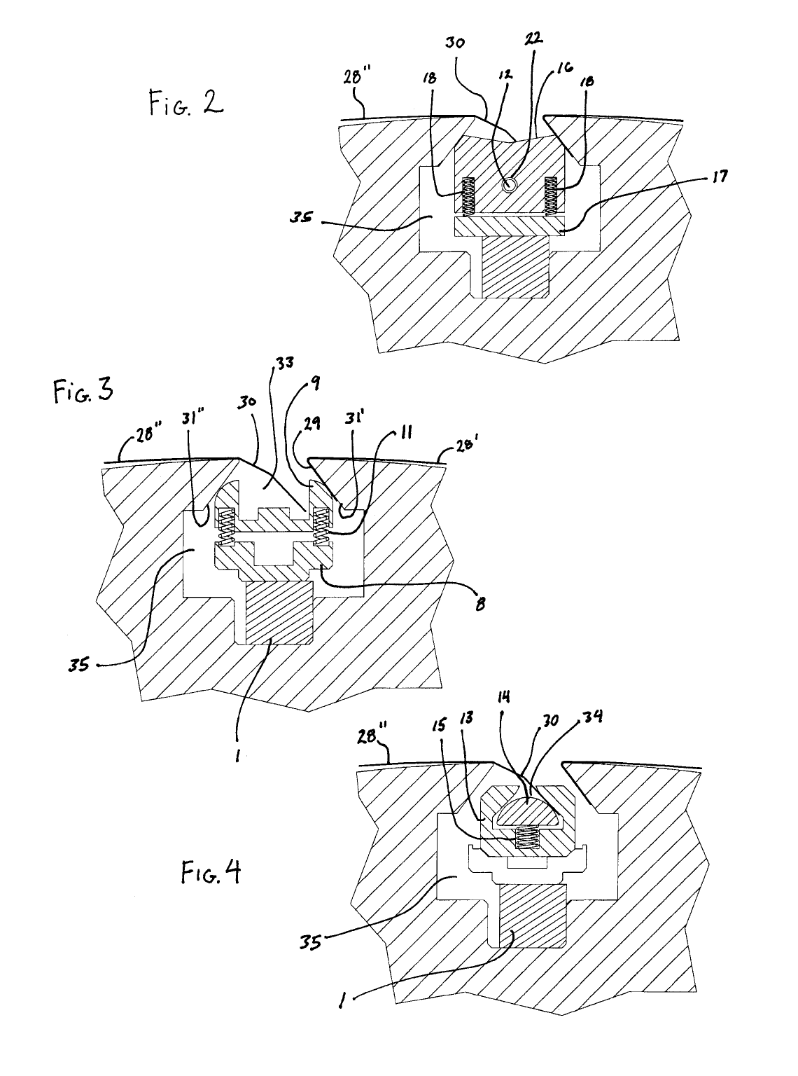

The filler bar 1 is used as a mounting surface to mount the assemblies into a cylinder slot. To this end, the filler bar 1 may be secured to the bottom of a press cylinder slot, such as shown in FIGS. 2-4, using mounting screws 2. The mounting screws 2 are inserted through lock mounting holes 23 that align with holes in the bottom of the cylinder slot, which are not shown. Multiple patterns of mounting holes 23 may be provided to accommodate different cylinder slot styles, making the filler bar 1 a universal or multipurpose adapter. The filler bar 1 height may be selected to position the plate lead clamp assembly 3, trail plate clamp assembly 4, and plate register assembly 6 at the correct height inside the cylinder slot. If necessary, one or more shims or adjustment screws may be provided between the filler bar 1 and the cylinder slot to accommodate different mounting height requirements. The filler bar 1 may have a plurality of tapped holes 24 for the lead clamp assemblies 3, trail plate clamp assemblies 4, and plate register assembly 6, to accommodate different web widths. When it is desired to change web widths, the installer simply relocates the parts to the proper tapped holes 24. Alternatively, the web width may be changed by replacing the filler bar 1.

While the illustrated filler bar 1 is mounted by screws 2, it may alternatively be secured within the cylinder slot by any appropriate means. For example, the filler bar 1 may be snapped into place, adhesively secured, secured magnetically, or secured or by any other means as necessary and/or desired. In still other embodiments, the filler bar 1 may be omitted. For example, this may be suitable where the filler bar is formed integrally with the cylinder slot, or where the plate lead clamp assembly 3, trail plate clamp assembly 4, and plate register assembly 6 are shaped or sized to be mounted directly to the bottom of the cylinder slot.

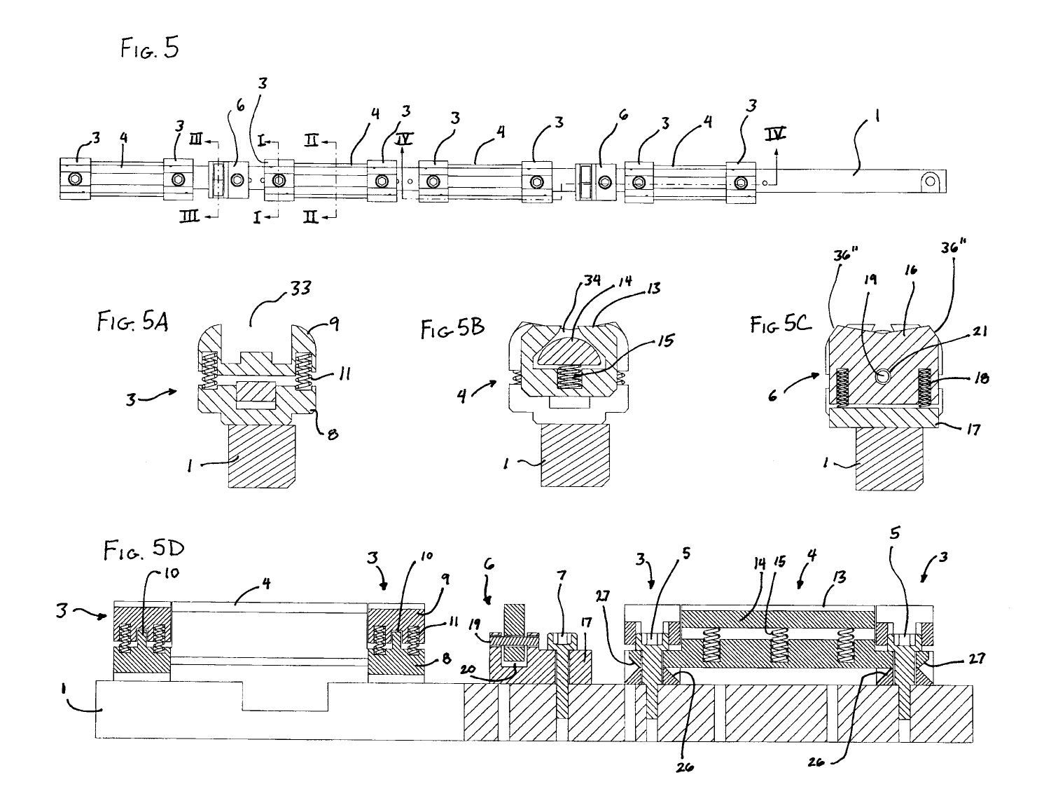

The lead clamp assemblies 3 are provided to lock the leading edge of a plate or plates in place in the cylinder slot. This is illustrated in FIG. 3, in which a lead clamp assembly 3 is shown clamping the leading edge 29 of one plate 28′ in place in a cylinder slot 35. Referring also to FIGS. 1, 5A and 5D, each exemplary lead clamp assembly 3 includes a lead clamp base 8, a lead clamp 9, dowel pins 10, shoulder bolts 12, and springs 11. The springs 11 are located between the lead clamp base 8 and lead clamp 9 and bias the lead clamp 9 away from the base 8. The springs 11 may be securely positioned by inserting them into corresponding machined slots or holes in the lead clamp 9, lead clamp base 8, or both.

One or more coil springs 11 may be used in the lead clamp assemblies 3, as shown, but it will be understood that these may be replaced by any other type or number of resilient biasing devices, such as one or more elastomeric blocks, leaf springs or pairs of magnets that are oriented to repel one another. In other embodiments, the biasing device or devices may comprise an actuated biasing device, such as cams, ramps or other movable members that are adapted to move the lead clamp 9 away from the lead clamp base 8 by use of a tool or other mechanism. For example, the springs 11 may be replaced by pneumatic bladders located between the lead clamp 9 and the lead clamp base 8, and that are operated by a central air supply that inflates the bladders to press the lead clamp 9 away from the base 8. Of course, combinations of resilient and actuated biasing devices may be used in other embodiments. For example, the biasing device may comprise a cam that is operated by a spring to bias the lead clamp 9 away from the base 8. The selection of the most desirable biasing device for any given application can vary depending upon various factors, such as the desire to provide a simple construction, which might favor using a resilient biasing device, or the desire to provide a remotely-operable lock or a stronger locking force, which might favor using an actuated biasing device. These and other factors and considerations will be apparent to those of ordinary skill in the art in view of the present disclosure.

As shown primarily in FIGS. 1 and 5D, one or more travel guides, such as dowel pins 10, may be provided between the lead clamp base 8 and lead clamp 9 to control the movement of the lead clamp 9. The dowel pins 10 may be formed separately and pressed into machined holes in the lead clamp base 8, or formed as part of the lead clamp base 8 or lead clamp 9. The dowel pins 10 also may be replaced by non-circular pins, or the travel guides may simply comprise matching sliding surfaces on the lead clamp base 8 and the lead clamp 9. For example, the pins 10 may be replaced by grooves on the base 8, and ribs on the clamp 9 that fit into and slide along the grooves. Of course, if they are determined not to be necessary, the travel guides may be omitted entirely. This may be appropriate, for example, where the springs 11 are sufficiently rigid to provide the proper relative movement between the lead clamp base 8 and lead clamp 9, or where the lead clamp 9 is otherwise constrained from moving too far from the desired travel path. In addition, if necessary or desired, the dowel pins 10 or other travel guides may be treated, coated or lined to ease relative movement between the lead clamp base 8 and the lead clamp 9. For example, the holes in the lead clamp 9 into which the dowel pins 10 are inserted may have a low-friction lining and/or be oiled or greased to reduce friction between the parts.

The exemplary lead clamp base 8 and lead clamp 9 may be held together by a retainer that prevents the lead clamp 9 from moving too far away from the lead clamp base 8, and allows the lead clamp assembly 3 to be handled outside the cylinder slot 35 without falling into multiple pieces. In the exemplary embodiment, the retainer comprises one or more shoulder bolts 12 that pass through clearance holes in the lead clamp base 8 and are screwed into the lead clamp 9. The shoulder bolts 12 are sized to allow the lead clamp 9 to move along the dowel pins 10, but still hold the lead clamp assembly 3 together by preventing the lead clamp 9 from moving past the dowel pins 10 and/or springs 11. This can be accomplished, for example, by making the threaded portion of the shoulder bolt 12 long enough to securely hold the lead clamp 9, but terminating the threads at a shoulder portion that extends to the bolt head. The shoulder portion is selected to be long enough to allow the lead clamp 9 to move the desired distance from the lead clamp base 8, and the bolt head is retained by the lead clamp base 8 to prevent any further movement. The lead clamp assembly 3 preferably is assembled before it is inserted into the cylinder slot 35 by positioning the springs 11 in their proper locations and installing the shoulder bolts 12 to capture the springs 11 in place and allow some movement between the lead clamp base 8 and the lead clamp 9. In alternative embodiments, the shoulder bolts 12 can be replaced by any other kind of retainer that limits the travel distance of the lead clamp 9. For example, the shoulder bolts 12 may be replaced by hook-like structures that extend from the lead clamp 9 to wrap around the bottom of the lead clamp base 8, but only contact the lead clamp base 8 once the lead clamp 9 has traveled a predetermined distance from the base 8. In still another embodiment, the shoulder bolts 12 or other retainer or retainers can also be configured to act as a travel guide to replace the dowel pins 10 or other travel guide structures. In another embodiment, the shoulder bolts 12 may be replaced by conventional screws around which a tubular spacer is placed to serve the role of the shoulder portion of the shoulder bolt 12. These modifications can, of course, be used in each instance described herein in which shoulder bolts or other retaining devices are described. Furthermore, in other embodiments, the retainer may be omitted entirely.

As best shown in FIG. 3, the lead clamp assembly 3 preferably is sized and/or shaped such that it can be installed into the cylinder slot even when it is fully assembled. This can be accomplished by making the lead clamp assembly 3 narrow enough to be simply slid or dropped into the slot. In many cases, however, the cylinder slot 35 is configured to have one or more inwardly-angled slot walls 31′, 31″ against which the leading edge 29 of the plate 28′ is clamped to hold the plate 28′ in place. This inverted V-shaped cylinder slot profile is often used because it decreases the width of the slot opening at the surface of the print cylinder, which decreases the paper margin, increases the printing surface, and reduces wasted paper. This creates a problem, however, because the lead clamp (and often the trail clamp and register) must be shaped and positioned so that it bears upon one or both of the inwardly-angled walls 31′, 31″ to provide the necessary clamping force. Thus, the lead clamp, when fully assembled, can be larger than the slot through which it must fit. To overcome this, previously-known lead clamps, trail clamps and registers that were used for inverted V slots were typically assembled piece-by-piece in the slot itself. An example of such a device is shown in U.S. Pat. Nos. 6,401,617 and 6,578,484. This process can be time consuming and difficult, but might be necessary if the slot width is too narrow to accommodate the parts if they are assembled before installation.

It has been discovered that the process of assembling the various lead clamp assembly parts within the cylinder slot can be avoided. For example, by configuring the lead clamp assembly 3 as a modular assembly that it can be fit through the slot opening sideways (or at an angle other than horizontal) then rotated into position on the filler bar 1, the lead clamp assembly 3 can be assembled outside the slot (that is, its constituent parts can be assembled to one another), and it need only be fastened to the filler bar 1 once it is placed in the filler bar. Of course, other parts may be added to the lead clamp assembly 3 once it is in the cylinder slot, but at least some of the moving parts are pre-assembled, which saves time and eases the difficulty of installing the lead clamp assembly.

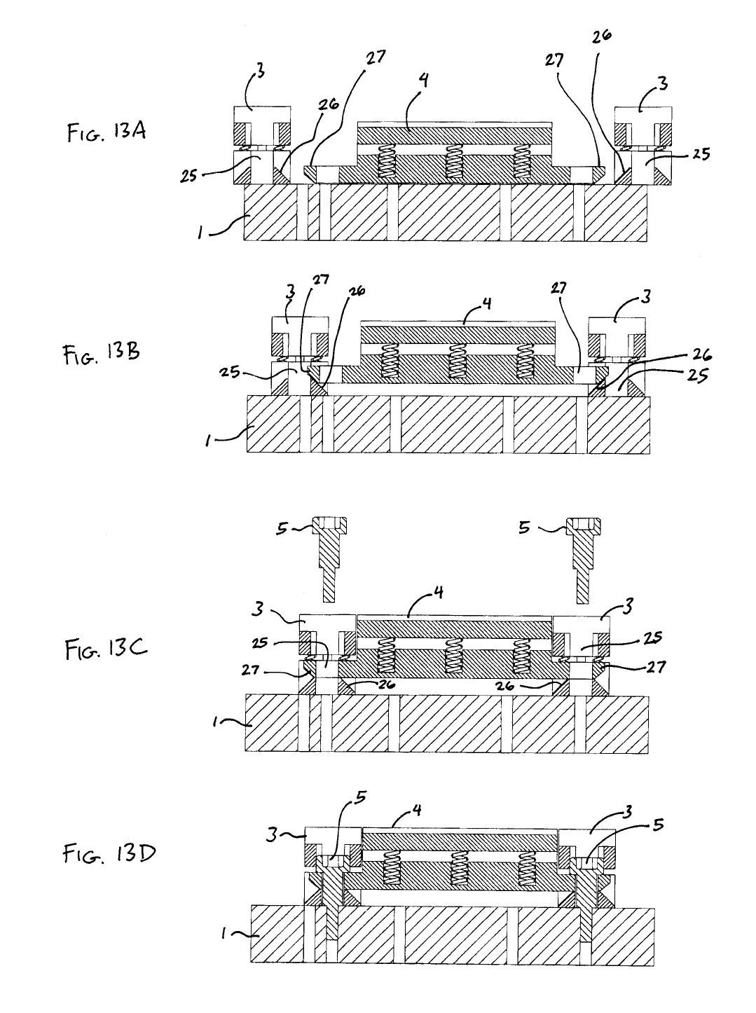

An example of such an assembly is provided in the embodiment of FIGS. 1-5D. In this exemplary embodiment, the lead clamp assembly 3 has a generally “U”-shaped profile that can be fully assembled outside of the cylinder slot, and installed by hooking one end of the “U” around the leading or trailing edge of the cylinder slot, then rotating the lead clamp 9 to pass the rest of the “U” shape into the slot. This process is explained in detail with reference to FIGS. 11A-D. As shown in FIG. 11A, the lead clamp assembly 3 is initially rotated so that it is pointing slightly downwards, which allows one side of the lead clamp 9 to fit into the slot opening 32. Next, the lead clamp assembly 3 is rotated such that the one inwardly-angled wall 31′ protrudes into a void area 33 in the lead clamp assembly profile, as shown in FIG. 11B. The lead clamp assembly 3 then is rotated to allow the remaining portion of the lead clamp 9 to fit into the slot opening 32, as shown in FIG. 11C, and this rotation is continued until the lead clamp assembly 3 is seated on the filler bar 1 (FIG. 11D) or the bottom of the slot 35. Once in place, it is only necessary to install a fastener or fasteners to attach the lead clamp assembly 3 to the filler bar 1 or slot 35. If necessary, the lead clamp 9 can be pressed against the lead clamp base 8 to reduce the size of the lead clamp assembly 3 to allow it to fit through the slot opening 32. Also, if there is insufficient room between the lead clamp assembly 3 and the filler bar 1 to rotate the lead clamp assembly 3 into place, one or more cutouts may be made in the filler bar 1 to allow the necessary rotation.

Once the lead clamp assembly 3 is installed into the cylinder, the springs 11 expand to press the lead clamp 9 against the inwardly-angled walls 31′, 31″. Preferably, the springs 11 remain at least slightly compressed even when the lead clamp 9 is pressed against the walls to thereby provide sufficient clamping force. The lead clamp base 8, lead clamp 9, and springs 11 are dimensioned such that the lead clamp 9 can be pushed towards the lead clamp base 8 to insert the leading edge 29 of the flexible printing plate 28′ in the nip between the lead clamp 9 and the angled surface 31′ of the plate cylinder, as shown in FIG. 3. Clearance of more than about 0.008-0.012 inches is necessary to accommodate most printing plates, but other tolerances may be used if desired. Additional clearance may be provided to allow the installer to compress the lead clamp assembly 3 even farther to help rotate it into place between the filler bar 1 and the angled slot surface. Once installed, the exemplary lead clamp assembly 3 has two lead clamp surfaces that each abut one of the inwardly-angled walls 31′, 31″, which provides a double-acting lock that can hold a plate's leading edge regardless of which way the cylinder rotates. In other embodiments, one of the clamp surfaces may be omitted.

In the foregoing embodiment, the lead clamp assembly 3 height and width dimensions can be larger than the slot opening width, but the void area 33 allows the lead clamp assembly 3 to be rotated as it is inserted to “roll” it through the slot opening 32 and into the slot 35. In other embodiments, the height dimension may be smaller than the width of the slot opening 32, which makes it unnecessary to roll the lead clamp assembly 3 to fit it through the slot, and eliminates the need for the void area 33. While the foregoing embodiments allow the lead clamp assembly 3 to be assembled before it is mounted in the slot 35, this is not strictly necessary in all embodiments. As such, in other embodiments, the lead clamp assembly 3 can be installed in place in the slot 35.

Referring back to FIG. 1, the trail clamp assembly 4 may comprise a trail clamp base 13, a trail clamp 14, and springs 15. The trail clamp base 13 of the exemplary embodiment includes a cavity having inwardly-angled walls that terminate at a trail clamp slot 34. As best shown in FIG. 4, the trail clamp 14 is fitted into the cavity in the trail clamp base 13 such that it is captured, in the vertical direction, within the trail clamp base 13. Springs 15 or other biasing devices are positioned between the trail clamp base 13 and trail clamp 14 to bias the trail clamp 14 upwards against the inwardly-angled walls of the base 13. If desired, the springs 15 may be inserted into holes bored or otherwise formed in the trail clamp base 13, in the trail clamp 14, or in both parts. The trail clamp 14 may be installed in the trail clamp base 13 by compressing the coil springs 15 using a flat plate-like tool, such as the device 37 shown in FIG. 10, then sliding the trail clamp 14 into the trail clamp base 13 from the end. Of course, in alternative embodiments, other assembly methods may be used. For example, the trail clamp 14 may first be installed in the trail clamp base 13, then the springs 15 may be compressed and slid into place, or the springs 15 may be installed through holes through the bottom of the trail clamp base 13. In will also be understood that the coil springs 15 may be replaced by one or more suitable biasing devices, such as a resilient biasing device (e.g., leaf springs, elastomers, opposing magnets), an actuated biasing device (e.g., cams, levers, air bladders), or a combination thereof. Such alternatives will be apparent to those of ordinary skill in the art in view of the present disclosure. In addition, the trail clamp assembly 4 may include features such as travel guide structures to help control its travel path, or retainers to prevent excess movement of the travel clamp 14.

The trail clamp assembly 4 may operate somewhat differently from the lead clamp assembly in that it does not use the inwardly-angled walls 31′, 31″ of the cylinder slot 35 as a clamping surface. Instead, the trail clamp assembly 4 receives the trailing edge 30 of the plate 28″ in the trail clamp slot 34, which faces upwards like the cylinder slot 35. When the trailing edge 30 is inserted into the trail clamp slot 34, it fits in a nip between the trail clamp 14 and the trail clamp base 13. The coil springs 15 press the trail clamp 14 against the inner surfaces of the trail clamp base 13. These inner surfaces taper inwards towards the top of the trail clamp slot 34, as shown in FIGS. 4 and 5B. Clearance in this nip of more than about 0.008-0.012 inches is preferred to accommodate typical plates, but other tolerances may be used. In order to accommodate printing plates having a variety of different trailing edge bend angles, the inner surfaces of the trail clamp base 13 against which the trail clamp 14 presses may be radiused or otherwise curved. Similarly, the trail clamp 14 has a rounded or curved profile that faces the inner surfaces. This is best shown in FIGS. 4 and 5B. This construction is believed to allow the plate trailing edge 30 to gently slide between the trail clamp base 13 and the trail clamp 14, provide better clamping effort on plates having different trail plate bend angles, and prevent the trail clamp 14 from clamping the plate 28″ against any sharply-beveled edges that might overstress the plate.

Referring to FIGS. 4 and 12A-D, the trail clamp assembly 4 may also be provided as a modular assembly having moving parts that can be assembled, at least in part, prior to being inserted into the cylinder slot. For example, Like the lead clamp assembly 3, this may be accomplished by simply making one dimension of the trail clamp assembly profile narrower than the slot opening, so that the trail clamp assembly 4 can be slid straight into the slot 35. Alternatively, the trail clamp assembly 4 width and/or height may be wider than the slot, but shaped so that it can be rotated into place. For example, the trail clamp assembly 4 may be installed by hooking the opening above the trail clamp 14 over the leading or trailing edge of the cylinder slot as shown in FIG. 12A. Next, the trail clamp assembly 4 is rotated into the slot as one of the tapered walls 31′ protrudes into a void area (which may be the trail clamp slot 34 or another opening in the trail clamp assembly profile). The trail clamp assembly 4 is then further rotated to remove the tapered wall 31′ from the void area and drop the assembly 4 fully into the slot 30, as shown in FIG. 12C. FIG. 12D shows the trail clamp assembly resting on the filler bar 1 prior to being fixed in place.

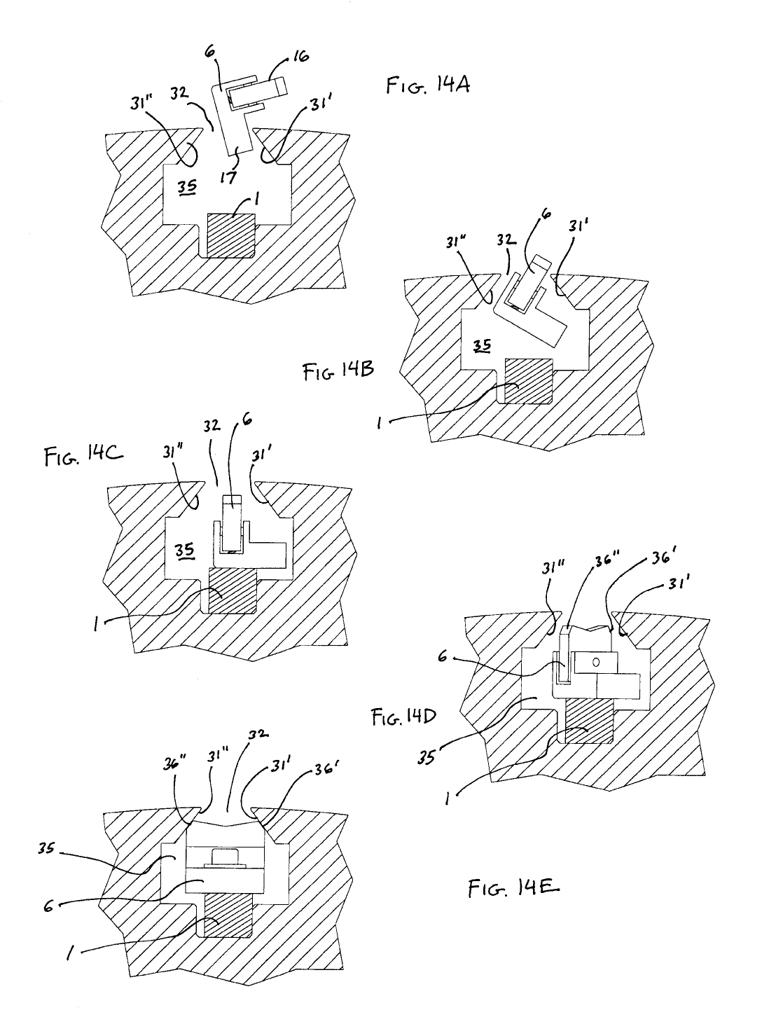

Once in the cylinder slot 35, the trail clamp assembly 4 requires no further assembly, and needs only to be rigidly fixed in place. This mounting may be accomplished, for example, by using one or more fasteners that are specific to the trail clamp assembly 4, or it may be captured in place by the lead clamp assemblies 3 as shown in FIG. 13D and described below. If the cylinder slot opening 32 is particularly narrow, it may be necessary to compress the trail clamp 14 against the trail clamp base 13 to complete the insertion, but this is not required in all embodiments. Also, if there is insufficient room between the trail clamp assembly 4 and the filler bar 1 to rotate the trail clamp assembly 4 into place, one or more cutouts may be made in the filler bar 1 to allow the necessary rotation.

Any combination of lead clamp assemblies 3 and trail clamp assemblies 4 may be used to provide the necessary clamping force for the leading and trailing edges of the printing plates. In the shown embodiment of FIGS. 1, 5 and 5D, the trail clamp assembly 4 may be positioned between and suspended by two lead clamp assemblies 3. To this end, each lead clamp assembly 3 includes a ramp 26, and the trail clamp assembly 4 includes a pair of ramped tabs 27 that fit onto the ramps and, when fully assembled, hold the trail clamp assembly at the correct operating height. An exemplary assembly process is illustrated in FIGS. 13A-D. As shown in FIG. 13A, the lead clamp assemblies 3 are positioned in the slot and on top of the filler bar 1, and the trail clamp assembly 4 is placed between the lead clamp assemblies 3. The lead clamp assemblies 3 are then moved towards one another, and as the ramps 26 abut the ramped tabs 27, they begin to lift the trail clamp assembly 4 away from the filler bar 1, as shown in FIG. 13B. Although such ramps 26 may be provided only on one side of each lead clamp assembly 3, it is more preferred to provide ramps 26 on both sides to allow the lead clamp assemblies 3 to be used on either side of the trail clamp assembly 4. Once the trail clamp assembly is fully raised, the lead clamp assemblies 3 are moved until mounting screw holes 25 through the lead clamp assemblies 3 and tabs 27 are aligned with one another and over corresponding mounting holes in the filler bar 1, as shown in FIG. 13C. Finally, the two lead clamp assemblies 3 and the trail clamp assembly 4 are attached to the filler bar 1 by two shoulder bolts 5. The shoulder bolts 5 pass through holes 25 through the trail clamp base 13 and the lead clamp base 8. These bolts 5 align the lead and trail clamp assemblies 3 and 4 and fix them to threaded holes 24 in the filler bar 1. Of course, the shoulder bolts 5 may be replaced by any suitable fastener, such as a screw having a tubular spacer or the like. In addition, although the holes 25 are illustrated as being round, they may instead be slots that allow transverse movement of the assembly along the axis of the cylinder slot, which may be useful to reposition the parts to accommodate alternate web widths.

It will be understood that various modifications to the foregoing interlocked arrangement of the lead and trail clamp assemblies may be made. For example, ramps may be provided only on one of the lead clamp assembly 3 or the trail clamp assembly 4, or they may be omitted entirely. It also may not be required to lift the trail clamp assembly 4 relative to the filler bar 1. In still another embodiment, a single lead clamp assembly may be mounted by and/or between two trail clamp assemblies, or the register assemblies 6 may be used as part of the foregoing mounting arrangement. In addition, it will be understood that in other embodiments, the lead clamp assemblies 3 and trail clamp assembly 4 may be mounted to the filler bar 1 by separate screws or other fasteners.

As shown in FIGS. 5 and 5D, the exemplary embodiment described above provides an advantage in that eight lead clamp assemblies 3, four trail clamp assemblies 4, and two registers 6 can be installed in a print cylinder slot using relatively few fasteners. For example, as shown, only ten fasteners (shoulder bolts 5 and screws 7) are required. These lead clamp, trail clamp and register assemblies can be used to provide all of the locking and registration requirements for a single print cylinder slot on a print cylinder sized to accommodate two side-by-side flexible plates. Of course, if a single-wide arrangement is used, only four lead clamp assemblies 3, two trail clamp assemblies 4, one register assembly 6, and five fasteners would be required. In comparison to prior art devices, this can provide an advantage by reducing assembly time and complexity. It will be understood that the foregoing calculations do not include the fasteners required to install the filler bar 1, if a filler bar 1 is used. Of course, this configuration may be varied to suit particular applications or to provide other embodiments, and additional or fewer fasteners may be used if desired.

Referring once again to FIG. 1, one or more register assemblies may be provided to properly register printing plates in the cylinder slots by interacting with one or more register slots on the printing plate. The exemplary register assembly 6 comprises a register 16, register base 17, a biasing device, such as springs 18, and a retainer, such as retaining pin 19. As best shown in FIGS. 1, 2, 5C and 5D, the register 16 fits within a slot 20 in the register base 17, and the springs 18 are located between the register 16 and the register base 17. The springs 18 may be coil springs or any other types of resilient biasing device or actuated biasing device, and they may be fitted into holes formed in the register 16 and/or register base 17. In will be understood that these springs 18 may be replaced by one or more suitable biasing devices, such as a resilient biasing device (e.g., leaf springs, elastomers, opposing magnets), an actuated biasing device (e.g., cams, levers, air bladders), or a combination thereof. Such alternatives will be apparent to those of ordinary skill in the art in view of the present disclosure. The register assembly 6 also may include one or more travel guides, such as dowel pins 10 or other structures to help control its travel path.

The exemplary register assembly 6 is assembled by sliding the springs into holes in the register 16, compressing the register 16 into the slot 20 against the restoring force of the springs 18, and inserting the retaining pin 19 through holes 21 in the register base 17 and a hole 22 through the register 16. The hole 22 through the register 16 is slightly larger than the retaining pin 19, which allows the register 16 to move slightly relative to the register base 17. The retaining pin 19 may comprise a roll pin, a screw, or any other suitable device. Of course, other assembly methods or constructions may be used. For example, the register assembly 6 may be retained from the bottom by one or more shoulder bolts, as previously described with reference to the exemplary lead clamp assembly. Conversely, if desired, the shoulder bolts and other retainers described elsewhere herein may be replaced by holes and pins similar to those described immediately above.

The register assembly 6 may be provided as a modular assembly that can be assembled outside the cylinder slot, and installed in the cylinder slot without having at least some of its moving parts disassembled. A particular problem with installing the register assembly 6 arises because the register 16 must be located very close to the angled inner walls 31′, 31″ of the slot to prevent the printing plate from passing between the register 16 and the slot wall. Furthermore, all or most of the register width must be positioned in this manner to prevent the plate from moving laterally within the slot. Thus, in prior lock devices such as those shown in U.S. Pat. No. 6,401,617, the register would be inserted and raised on shims until it is close enough to the slot walls to prevent plates from passing between the two. This is a time consuming and relatively difficult process. In other devices, such as those shown in U.S. Pat. No. 6,578,484, which is incorporated herein by reference, the register was held in by a separate cradle and tightened into place by a jack screw. Such devices also were somewhat labor-intensive to install. The register assembly 6 of a preferred embodiment overcomes these disadvantages by being installable without using shims or jack screws. It will be understood, however, that these and other kinds of adjustment device may still be used with embodiments of the present invention, if desired.

The exemplary register assembly 6 has a generally “L”-shaped side profile, as shown in FIG. 5D. The register assembly 6 is installed into the cylinder slot 35 by aligning the register base 17 with the slot and sliding it into the slot 35, as shown in FIG. 14A. Once the register base 17 is extending into the slot 35, the register assembly is rotated to allow the register 16 to slide into the slot 35, as shown in FIG. 14B. At this point, the register 16 should be oriented in parallel with the slot 35, with the register base 17 resting on the filler bar 1, as shown in FIG. 14C. If there is insufficient room between the register assembly 6 and the filler bar 1 for the register assembly 6 to rotate into place, one or more cutouts may be made in the filler bar 1 to provide clearance to allow the necessary rotation. Once the register assembly 6 is resting on the filler bar 1, it is rotated, as shown in FIG. 14D, until it is turned ninety degrees relative to the slot 35 to thereby properly align the register 16 with the angled inner surfaces 31′, 31″ of the cylinder slot 35. To do so, the register 16 may be compressed, collapsing the coil springs 18, and providing sufficient clearance between the register's angled surfaces 36′, 36″ and the slot walls 31′, 31″ to allow the register assembly 6 to rotate ninety degrees into place. Once in place, the register 16 is released and the springs 18 press the angled surfaces 36′, 36″ into contact the angled surfaces 31′, 31″ of the cylinder slot 35. The clearance between the retaining pin 19 and hole 22 through the register 16 may be selected to provide sufficient clearance to the register 16 to be depressed to allow ninety degree rotation, but not enough clearance to allow a typical printing plate to be accidentally inserted between the register's angled surfaces 36′, 36″ and the angled cylinder slot walls 31′, 31″. For example, to allow the register 16 to be rotated into place, but prevent a typical 0.008-inch to 0.012-inch thick printing plate from fitting between the register 16 and the slot walls 31′, 31″, there may be enough clearance between the retaining pin 19 and hole 22 to allow the register to move towards the register base 17 by less than about 0.008 inches. In some embodiments, if the amount of travel provided by compressing the springs 18 is insufficient to allow the register 16 to be easily turned into place, it may be desirable to provide one or more cutouts in the filler bar 1 into which the register assembly 6 may be lowered to provide more clearance for rotation. Such cutouts could alternatively be made in the register assembly 6 itself.

Once in place, the register assembly 6 is secured by a mounting screw 7 or other suitable fastener. As with the other parts described above, it may be desirable to make the register assembly 6 adjustable to different positions to accommodate different web widths and web fanout by sliding it along the cylinder slot in the required direction. This may be accomplished, for example, by providing multiple mounting holes for the register assembly 6 along the length of the filler bar 1.

In an exemplary assembly process, the modular printing plate lock mechanism is installed into a printing press cylinder slot by first mounting the filler bar 1 to the cylinder slot bottom using mounting screws 2. Next, starting at the press center line, a lead clamp assembly 3 is inserted into the slot, then a trail clamp assembly 4 is inserted, and then another lead clamp assembly 3 is inserted on the other side of the trail clamp assembly 4. The two lead clamp assemblies 3 are pushed toward the trail clamp assembly 4, causing the trail clamp assembly 4 to raise up on the ramps 26 on the lead base clamps 8 to the correct the operational height. The two lead clamp assemblies 3 and the captured trail clamp assembly 4 then are fixed in place by the shoulder bolts 5. Next, a register assembly 6 is inserted into the cylinder slot, the register 16 is pressed down to compress the coil springs 18, and the register assembly 16 is rotated ninety degrees. Once the register assembly 6 is in position, a mounting screw 7 is installed through the register base 17 to fix the register assembly 6 to a threaded hole 24 in the filler bar 1. The process maybe repeated until the print cylinder is fully-equipped. Of course, various modifications to this process and the parts used in the process can be made.

The foregoing process provides relatively simple and efficient assembly of printing plate lock devices because the lead clamps, trail clamps and registers can be pre-assembled then inserted into the cylinder slot. Thus, the only assembly that must be done within the cylinder slot is securing the pre-assembled parts to the filler bar using a limited number of simple mounting screws. The process may be modified, however, to include some assembly of parts within the cylinder slot itself. For example, the lead and trail clamp assemblies may be assembled outside the cylinder slot, then installed as described above, while the register assemblies are assembled from multiple parts (such as shims and the like) within the cylinder slot. As another example, one or both of the lead clamp assembly and the trail clamp assembly may be assembled from multiple parts within the cylinder slot.

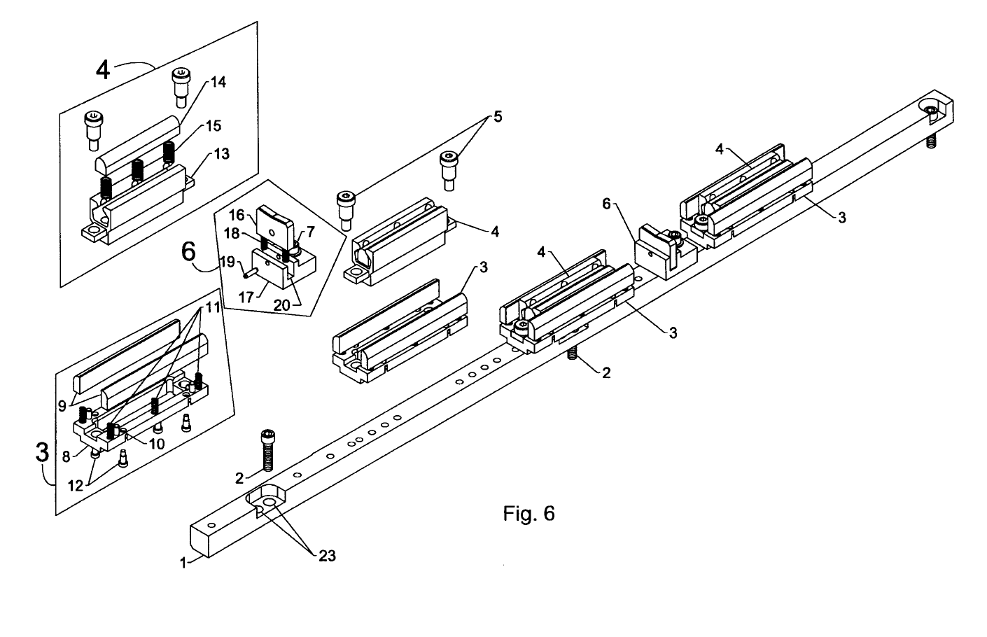

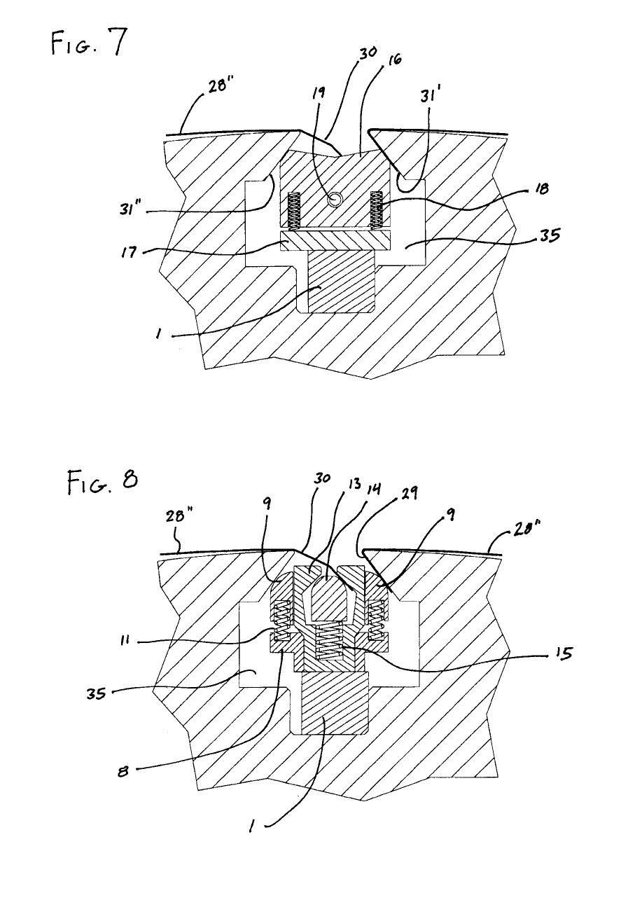

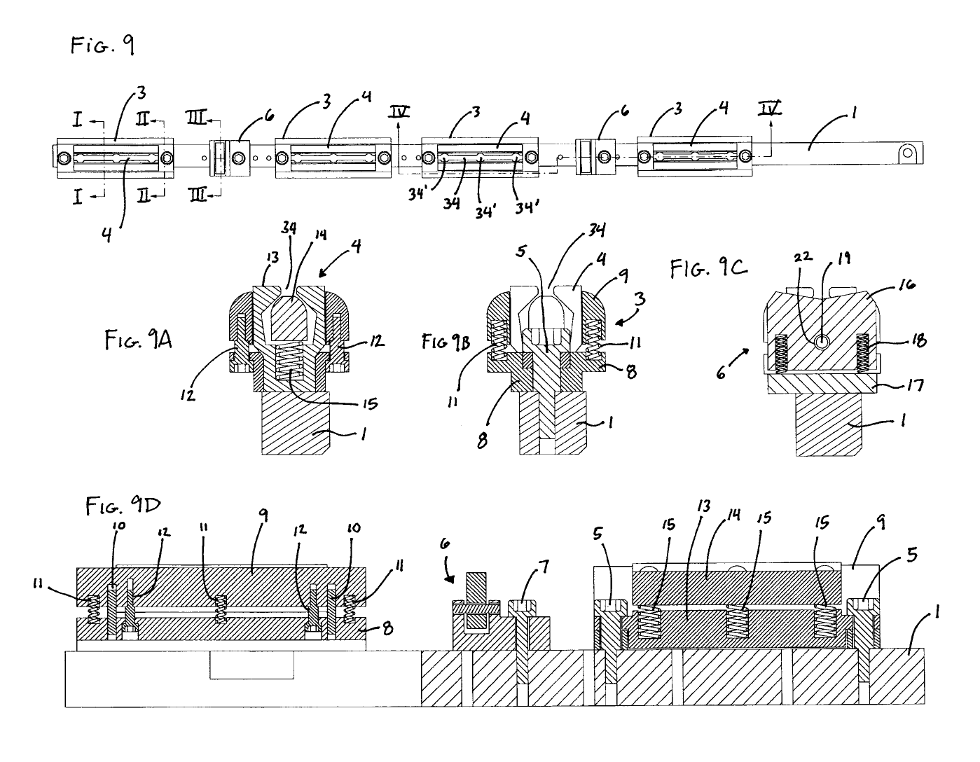

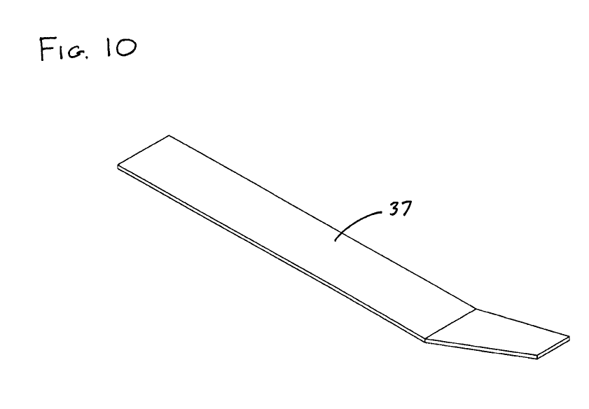

A second exemplary embodiment of the invention is shown in FIGS. 6-9D. In this embodiment, the lead clamp assembly 3 is elongated and provided as a single continuous assembly, rather than two separate lead clamp assemblies 3 as in the previous embodiment. The lead clamp 3 comprises a lead clamp base 8 to which a pair of lead clamps 9 are attached. The lead clamps 9 interact with respective inwardly-angled walls 31′, 31″ in the slot 35 to provide hold the leading edge 29 of a printing plate 28′ regardless of which direction the print cylinder rotates. Of course, on lead clamp 9 may be omitted, if desired, but in such a case the lead clamp assembly 3 would need to be turned 180 degrees to operate the print cylinder in the opposite direction. While the two lead clamps 9 are shown as two separate parts, they may be provided as a single part, or as a greater number of parts (i.e., two or more lead clamps 9 on each side of the lead clamp base 8). The lead clamps 9 may be retained by shoulder bolts 12 or other retainers, may be provided with travel guides, such as pins 10, and may use any suitable biasing device.

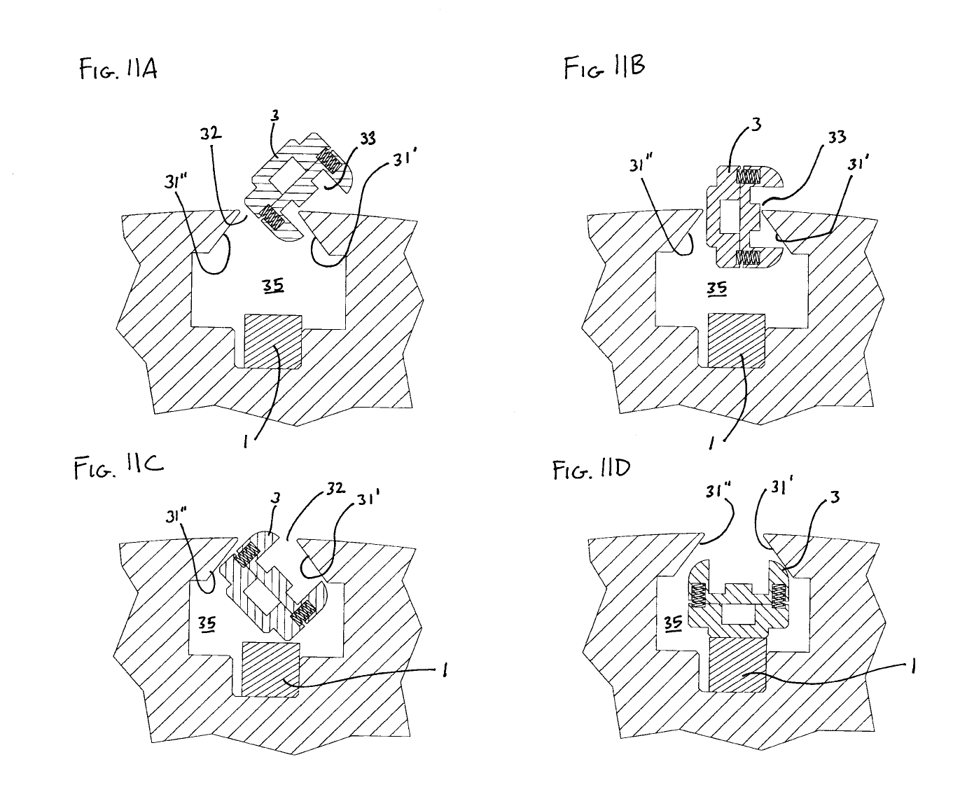

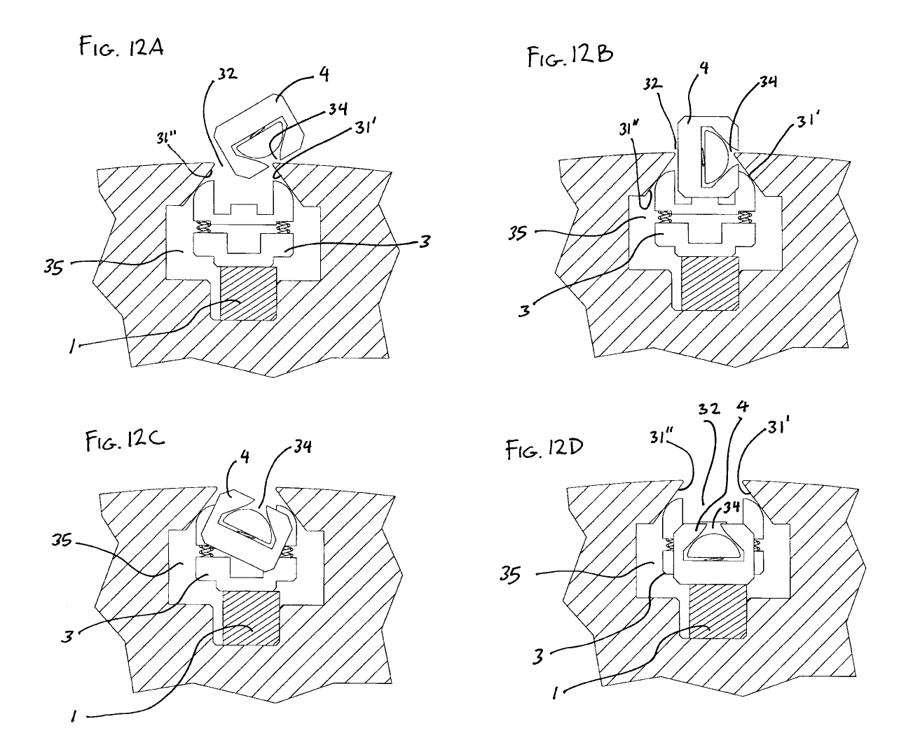

The trail clamp assembly 4 is similar to the previous embodiment but is nested within the lead clamp assembly 3 rather than being suspended between two lead clamp assemblies 3. The trail clamp assembly 4 includes a trail clamp base 13, a trail clamp 14, and springs 15 or other biasing devices. As shown in FIG. 9, the trail clamp base 13 has a trail clamp slot 34, which may include cutouts 34′ to allow the springs 15 to be dropped into place before the trail clamp 14 is inserted through the end of the trail clamp base 14. A tool 37 such as that shown in FIG. 10 may be used to depress the springs 15 before sliding the trail clamp 14 into place. Travel guides, retainers, or other devices also may be used, if desired. As with the previous embodiment, the lead clamp assembly 3 and trail clamp assembly 4 are installed together by two shoulder bolts 5. This embodiment reduces the total number of parts required for each lead clamp assembly 3 and reduces the number of assemblies that must be installed inside the cylinder slot. It also differs from the previous embodiment in that the trail clamp assembly 4 may be narrow enough to be dropped vertically into the recess within the lead clamp assembly 3 without being rotated or “rolled” into the slot 35.

The register assembly 6 of the embodiment of FIGS. 6-9D is the same as that shown in the previous embodiment, but this is not required. It will be understood that the register assembly 6 may be modified or replaced in other embodiments.

Referring to FIGS. 9 and 9D, it will be seen that this embodiment provides an advantage in that four lead clamp assemblies 3, four trail clamp assemblies 4, and two registers 6 can be installed in a print cylinder slot using relatively few fasteners. For example, as shown, only ten fasteners (shoulder bolts 5 and screws 7) are required (excluding any fasteners used to mount the filler bar 1). Of course, this configuration may vary, and additional or fewer fasteners may be used if desired.

The foregoing embodiments of plate lock devices may be constructed in any number of ways. In one embodiment, they are generally made from extruded and machined stainless steel. Extrusion allows the unfinished parts to be made with relative efficiency, and critical surfaces and details can to be finished or machined to required tolerances. In other embodiments, however, some or all of the parts may be made from other materials, formed as cast parts, or provided as composite materials. For example, any of the foregoing devices can be made generally from a plastic or composite material having metal inserts forming the critical surfaces. An example of this would be to manufacture the lead clamp assembly 3 generally from extruded plastic, but use stainless steel or titanium parts to form the surfaces of the lead clamp 9 that abut the printing plate during use. These and other variations will be understood in view of the present disclosure.

The foregoing embodiments are exemplary only, and other embodiments will be apparent to those of ordinary skill in the art in light of the teachings provided herein. Furthermore, the present invention provides a number of advances in the art of printing press cylinder locks, each of which is believed to provide a new and useful invention. The various inventions described herein can be used together, separately, or in any number of other combinations.

I claim:

1. A printing plate lock system for use with a print cylinder slot having inwardly-angled slot walls that terminate at a slot opening, the printing plate lock system comprising:
at least one lead clamp assembly comprising a plurality of lead clamp parts that are assembled together to form the lead clamp assembly, the lead clamp assembly having at least one lead clamp positioned adjacent at least one inwardly-angled slot wall;
at least one trail clamp assembly comprising a plurality of trail clamp parts that are assembled together to form the trail clamp assembly, the trail clamp assembly having at least one trail clamp; and
at least one register assembly comprising a plurality of register parts that are assembled together to form the register assembly, the register assembly having at least one register;
wherein at least one of the lead clamp assembly, the trail clamp assembly and the register assembly comprises a modular assembly having moving parts that are assembled together in a manner that allows limited relative movement between the moving parts, and wherein the modular assembly can be installed into the print cylinder slot through the slot opening without disassembling the moving parts.

2. The printing plate lock system of claim 1, wherein the lead clamp assembly and the trail clamp assembly each comprises a modular assembly having moving parts that are fully assembled together in a manner that allows limited relative movement between the moving parts, and wherein the lead clamp assembly and the trail clamp assembly each can be installed into the print cylinder slot through the slot opening without disassembling the moving parts.

3. The printing plate lock system of claim 1, wherein the lead clamp assembly, the trail clamp assembly and the register assembly each comprises a modular assembly having moving parts that are fully assembled together in a manner that allows limited relative movement between the moving parts, and wherein the lead clamp assembly, the trail clamp assembly and the register assembly each can be installed into the print cylinder slot through the slot opening without disassembling the moving parts.

4. The printing plate lock system of claim 1, wherein:
the at least one lead clamp assembly comprises one or two lead clamp assemblies;
the at least one trail clamp assembly comprises one trail clamp assembly; and
the one or two lead clamp assemblies and the one trail clamp assembly are adapted to be collectively rigidly fixed in the cylinder slot using only two fasteners.

5. The printing plate lock system of claim 1, wherein:
the at least one lead clamp assembly comprises four, eight or twelve lead clamp assemblies;
the at least one trail clamp assembly comprises four or six trail clamp assemblies;
the at least one register assembly comprises two or three register assemblies; and
the lead clamp assemblies, trail clamp assemblies and register assemblies are adapted to be rigidly fixed in a single print cylinder slot to provide all of the required locking and registration functions for the single print cylinder slot.

6. The printing plate lock system of claim 5, further comprising a filler bar adapted to be secured within the print cylinder slot, and wherein at least one of the lead clamp assembly, the trail clamp assembly and the register assembly is rigidly fixed to the filler bar.

7. A printing plate clamp assembly for use with a print cylinder slot having inwardly-angled slot walls that terminate at a slot opening, the printing plate clamp assembly comprising:
a base adapted to be rigidly mounted in the print cylinder slot;
a plate lock movably mounted to the base;
a biasing device adapted to apply a force to move the plate lock relative to the base along a first direction; and
a retainer adapted to limit the distance the plate lock can travel in the first direction;
wherein at least a portion of the printing plate clamp assembly is wider than the slot opening, and the printing plate clamp assembly is adapted to be passed through the slot opening and mounted in the print cylinder slot without disassembling the printing plate clamp assembly.

8. The printing plate clamp assembly of claim 7, wherein the biasing device applies the force to move the plate lock relative to the base towards the inwardly-angled slot walls, and the plate lock is adapted to lock a printing plate against the inwardly-angled slot walls.

9. The printing plate clamp assembly of claim 7, further comprising at least one travel guide adapted to substantially prevent the plate lock from moving relative to the base in any direction other than the first direction.

10. The printing plate clamp assembly of claim 7, wherein:
the base comprises one or more inwardly-angled base walls that form the retainer, and a clamp slot located at the end of the one or more inwardly-angled base walls;
the biasing device applies the force to move the plate lock towards the one or more inwardly-angled base walls; and
the plate lock is adapted to lock a printing plate against the one or more inwardly-angled base walls.

11. The printing plate clamp assembly of claim 7, wherein the plate lock comprises two clamp surfaces located adjacent opposite sides of the print cylinder slot, each plate surface extending generally in parallel with the print cylinder slot and radially inwardly of at least a portion of the inwardly-angled slot walls.

12. The printing plate clamp assembly of claim 11, wherein the two clamp surfaces are joined to one another.

13. A printing plate clamp assembly comprising:
a base adapted to be rigidly mounted in a print cylinder slot, the base having a central cavity having one or more inwardly-angled base walls and a clamp slot located at the end of the one or more inwardly-angled base walls;
a plate lock positioned generally within the cavity and movable relative to the base; and
a biasing device adapted to apply a force to move the plate lock relative to the base along a first direction towards the clamp slot;
wherein the plate lock is retained within the cavity with respect to movement in the first direction, and the printing plate clamp assembly is adapted to be mounted in a print cylinder slot without disassembling the printing plate clamp assembly.

14. The printing plate clamp assembly of claim 13, wherein the biasing device comprises one or more coil springs and the clamp slot comprises one or more cutouts adapted to allow installation of the one or more coil springs into the cavity.

15. The printing plate clamp assembly of claim 13, wherein the biasing device comprises one or more opposed magnets.

16. A printing plate lock system comprising:
at least one first plate clamp assembly adapted to be mounted in a print cylinder slot; and
at least one second plate clamp assembly adapted to be mounted in the print cylinder slot;
wherein the at least a portion of the second plate clamp assembly overlies at least a portion of the second plate clamp assembly, the first plate clamp assembly and the second plate clamp assembly are simultaneously mounted in the print cylinder slot by at least one common fastener, and one of the first plate clamp assembly and the second plate clamp assembly comprises a lead clamp adapted to lock a printing plate leading edge, and the other of the first plate clamp assembly and the second plate clamp assembly comprises a trail clamp adapted to lock a printing plate trailing edge.

17. The printing plate lock system of claim 16, wherein:
the at least one first plate clamp assembly comprises one first plate clamp assembly;
the at least one second plate clamp assembly comprises two second plate clamp assemblies; and
the first plate clamp assembly is mounted between the two second plate clamp assemblies.

18. The printing plate lock system of claim 17, wherein the first plate clamp assembly is suspended between the two second plate clamp assemblies.

19. The printing plate lock system of claim 18, wherein the first plate clamp assembly and the two second plate clamp assemblies comprise corresponding facing surfaces that engage one another to hold the first plate clamp assembly between the two second plate clamp assemblies.

20. The printing plate lock system of claim 19, wherein the corresponding facing surfaces comprise one or more ramped surfaces that are adapted to lift the first plate clamp assembly into place between the two second plate clamp assemblies in response to moving the two second plate clamp assemblies towards the first plate clamp assembly.

21. A printing plate register assembly for use with a print cylinder slot having inwardly-angled slot walls that terminate at a slot opening, the register assembly comprising:
a base adapted to be rigidly mounted in the print cylinder slot;
a register movably mounted to the base, the register comprising first and second register surfaces adapted to underlie and face respective ones of the inwardly-angled slot walls;
a biasing device adapted to apply a force to move the register relative to the base along a first direction; and
a retainer adapted to limit the distance the register can travel in the first direction;
wherein the register assembly is adapted to be passed through the slot opening and mounted in the print cylinder slot without disassembling the register assembly.

22. The printing plate register assembly of claim 21, wherein the register assembly is adapted to rotate from an installation position in which the register is substantially not perpendicular to the print cylinder slot to a use position in which the register is substantially perpendicular to the print cylinder slot.

23. The printing plate register assembly of claim 21, wherein the register comprises a register hole and the retainer comprises a pin passing through the register hole.

24. The printing plate register assembly of claim 21, wherein the register can move relative to the base by less than about 0.008 inches.

25. The printing plate register assembly of claim 21, wherein the biasing device automatically raises the first and second register surfaces towards respective ones of the inwardly-angled slot walls when the register assembly is installed in the print cylinder slot.
